(19) United States
(12) Patent Application Publication
(10) Pub. No.: US 2013/0015175 A1
(43) Pub. Date: Jan. 17, 2013

(54) METHOD FOR PRODUCING SILICON

(71) Applicants: Alfons Karl, Grundau (DE); Jürgen Erwin Lang, Karlsruhe (DE); Hartwig Rauleder, Rheinfelden (DE); Bodo Frings, Schloss Holte (DE)

(72) Inventors: Alfons Karl, Grundau (DE); Jürgen Erwin Lang, Karlsruhe (DE); Hartwig Rauleder, Rheinfelden (DE); Bodo Frings, Schloss Holte (DE)

(21) Appl. No.: 13/509,838

(22) PCT Filed: Nov. 4, 2010
(86) PCT No.: PCT/EP10/66833

§ 371 Date: May 15, 2012

(30) Foreign Application Priority Data
Nov. 16, 2009 (EP) 09176051.2

(51) Int. Cl. H01B 1/04; F27D 11/00

(52) U.S. Cl. 219/385; 252/502; 252/504

(57) ABSTRACT

The present invention relates to an improved process for producing silicon, preferably solar silicon, using novel high-purity graphite mouldings, especially graphite electrodes, and to an industrial process for production of the novel graphite mouldings.

The present invention relates to an improved process for producing silicon, preferably solar silicon, using novel high-purity graphite mouldings, especially graphite electrodes, and to an industrial process for production thereof.

The production of solar silicon from silicon dioxide and carbon at high temperature is known. This process is preferably performed in a light arc furnace with graphite electrodes. Since the solar silicon must have a very high purity, the electrodes or other furnace constituents must not introduce any impurities into the silicon melt. In addition to the electrodes, many other constituents of the furnace are therefore also produced from graphite.

The main constituent of graphite electrodes is typically petroleum coke, which is produced from distillation residues from mineral oil. In addition, graphite, coke from hard coal and carbon black are also used. The binders used are pitches, or else phenol resins and furfural resins. The fillers are mixed vigorously and homogeneously with the binders and shaped to green bodies in extruders or in isostatic presses. This is followed by the calcination of the green bodies with exclusion of oxygen at temperatures of 600-1200° C., and graphitization in the temperature range of 1800-3000° C., in the course of which the purity of the material increases considerably since virtually all impurities evaporate. The properties of the electrode are determined by:
the raw material selected, i.e. type and particle size+proportions thereof in the formulation,
the type, the amount and the state of the binder,
the heating rates and temperatures in the course of calcination and graphitization,
the impregnation of the calcined and graphitized materials.

In addition to the electrode material, a reducing agent is required in the production of solar silicon from silicon dioxide. For this purpose, the use of sugar as a reducing agent with a low proportion of impurities (U.S. Pat. No. 4,294,811, WO 2007/106860) or as a binder (U.S. Pat. No. 4,247,528) is known. The sugar is pyrolysed in situ in the furnace or in a preceding step.

For instance, U.S. Pat. No. 5,882,726 discloses a process for preparing a carbon-carbon composition wherein a pyrolysis of a low-melting sugar is carried out.

GB 733 376 discloses a process for purifying a sugar solution and for pyrolysis at 300 to 400° C.

Likewise known is the pyrolysis of sugar at high temperature in order to obtain an electron-conductive substance (WO 2005/051840).

In the industrial scale pyrolysis of carbohydrates, however, there can be problems resulting from caramelization and foam formation, which can considerably disrupt the conduct and running of the process.

It was therefore an object of the present invention to improve the process for producing silicon by reduction of silicon dioxide with carbon. A specific object was to improve the apparatus characteristics such that the costs for the production of the high-purity apparatus constituents required are lowered, but the impurities are at the same time kept at at least the same level as in the known processes. It was a further specific object to develop novel materials for high-purity apparatus constituents and a process for production thereof.

Further objects which are not stated explicitly are evident from the overall context of the description, examples and claims which follow.

These objects are achieved in accordance with the invention according to the details in the claims, the description which follows and the examples.

It has thus been found that, surprisingly, pyrolysis of carbohydrates can give carbon materials from which high-purity graphite mouldings for furnaces, especially light arc furnaces, can be obtained.

Carbohydrates, preferably sugars as starting material have the advantage that they are obtainable virtually anywhere in the world in sufficient amounts with nearly the same purity. In addition, sugar by its nature has very low contamination by boron and phosphorus. Therefore, the purification complexity of the reactants is reduced significantly compared to the reactants used in the prior art. Finally, sugar is a very inexpensive raw material which, as compared with fossil raw materials, is renewable and will therefore also still be available in sufficient amounts in the future.

In a specific embodiment, the carbohydrate, preferably the sugar, is pyrolysed in the presence of a silicon oxide, preferably SiO₂, especially precipitated silica and/or fumed silica and/or silica gel. One advantage of this process is that the silicon oxide suppresses the foam formation effect in the pyrolysis, and hence an industrial process for pyrolysis of carbohydrates can now be operated in a simple and economically viable manner without troublesome foam formation.

Furthermore, a reduction in caramelization was also observed in the performance of the process according to the invention.

It has also been found that, in the pyrolysis of carbohydrates in the presence of silicon oxides, preferably silicon dioxide, a pyrolysis product (also referred to hereinafter as pyrolysate) is obtained, which can be processed further in a particularly advantageous manner to graphite mouldings, preferably graphite electrodes. This affords graphite electrodes doped with silicon oxides, preferably silicon dioxide, and/or silicon carbide. Without being bound to a particular theory, the applicants are of the view that the doping results in preferential formation of silicon in the melt of the light arc furnace over the formation of silicon carbide, and thus enabling achievement of a higher yield of silicon additionally having a higher purity.

The present invention therefore provides a process for producing silicon, preferably solar silicon, by reduction of silicon dioxide with carbon, characterized in that it is performed in a light arc furnace and in that at least parts of the furnace or of the electrodes are produced from a graphite material which is in turn obtained from a carbon material which is obtained by pyrolysis of at least one carbohydrate, preferably at least one sugar.

The remaining portions of the graphite mouldings may consist of the materials used customarily for production of such parts; these materials are preferably in highly pure form, such that the graphite mouldings preferably have the spectrum of impurities defined below.

The present invention likewise provides the process described above, but characterized in that the pyrolysis of the carbohydrate is performed in the presence of at least one silicon oxide.

The present invention also provides graphite mouldings, preferably mouldings of a light arc furnace, more preferably graphite electrodes, characterized in that, they have been doped with silicon oxides, preferably silicon dioxide, and/or SiC. In a particular embodiment, these are high-purity graphite mouldings, which have the following profile of impurities:
a. aluminium less than or equal to 5 ppm, preferably between 5 ppm and 0.0001 ppt, especially between 3 ppm and 0.0001 ppt, preferably between 0.8 ppm and 0.0001 ppt, more preferably between 0.6 ppm and 0.0001 ppt, even better between 0.1 ppm and 0.0001 ppt, most preferably between 0.01 ppm and 0.0001 ppt, even greater preference being given to from 1 ppb to 0.0001 ppt;
b. boron less than 10 ppm to 0.0001 ppt, especially in the range from 5 ppm to 0.0001 ppt, preferably in the range from 3 ppm to 0.0001 ppt or more preferably in the range from 10 ppb to 0.0001 ppt, even more preferably in the range from 1 ppb to 0.0001 ppt;
c. calcium less than or equal to 2 ppm, preferably between 2 ppm and 0.0001 ppt, especially between 0.3 ppm and 0.0001 ppt, preferably between 0.01 ppm and 0.0001 ppt, more preferably between 1 ppb and 0.0001 ppt;
d. iron less than or equal to 20 ppm, preferably between 10 ppm and 0.0001 ppt, especially between 0.6 ppm and 0.0001 ppt, preferably between 0.05 ppm and 0.0001 ppt, more preferably between 0.01 ppm and 0.0001 ppt, and most preferably from 1 ppb to 0.0001 ppt;
e. nickel less than or equal to 10 ppm, preferably between 5 ppm and 0.0001 ppt, especially between 0.5 ppm and 0.0001 ppt, preferably between 0.1 ppm and 0.0001 ppt, more preferably between 0.01 ppm and 0.0001 ppt, and most preferably between 1 ppb and 0.0001 ppt;
f. phosphorus less than 10 ppm to 0.0001 ppt, preferably between 5 ppm and 0.0001 ppt, especially from less than 3 ppm to 0.0001 ppt, preferably between 10 ppb and 0.0001 ppt and most preferably between 1 ppb and 0.0001 ppt;
g. titanium less than or equal to 2 ppm, preferably from less than or equal to 1 ppm to 0.0001 ppt, especially between 0.6 ppm and 0.0001 ppt, preferably between 0.1 ppm and 0.0001 ppt, more preferably between 0.01 ppm and 0.0001 ppt, and most preferably between 1 ppb and 0.0001 ppt;
h. zinc less than or equal to 3 ppm, preferably from less than or equal to 1 ppm to 0.0001 ppt, especially between 0.3 ppm and 0.0001 ppt, preferably between 0.1 ppm and 0.0001 ppt, more preferably between 0.01 ppm and 0.0001 ppt, and most preferably between 1 ppb and 0.0001 ppm.

Impurities can be determined, for example—but not exclusively—by means of ICP-MS/OES (inductively coupled spectrometry—mass spectrometry/optical electron spectrometry) and AAS (atomic absorption spectroscopy).

The inventive graphite mouldings preferably have a ratio of carbon to silicon (calculated as silicon dioxide) of 400:0.1 to 0.4:1000, more preferably of 400:0.4 to 4:10; even more preferably of 400:2 to 4:1.3 and especially of 400:4 to 40:7.

The process according to the invention is notable more particularly in that the graphite mouldings are produced from a carbon material which has been obtained by pyrolysis of at least one carbohydrate, preferably at least one sugar, the pyrolysis in preferred variants having been performed in the presence of at least one silicon oxide.

The process according to the invention allows the pyrolysis of the carbohydrate to be performed at very low temperatures. Thus, it is advantageous, since it is particularly energy-saving (low-temperature mode), in the process according to the invention to lower the pyrolysis temperature of 1600° C. to 1700° C. to below 800° C. For instance, the process according to the invention in a first preferred embodiment, is operated preferably at a temperature of 250° C. to 800° C., more preferably at 300 to 800° C., even more preferably at 350 to 700° C. and especially preferably at 400 to 600° C. This process is exceptionally energy-efficient and additionally has the advantage that caramelization has reduced and the handling of the gaseous reaction products is facilitated.

However, it is also possible in principle, in a second preferred embodiment, to perform the reaction between 800 and 1700° C., more preferably between 900 and 1600° C., even more preferably at 1000 to 1500° C. and especially at 1000 to 1400° C. In general, a pyrolysis product with a higher graphite content is obtained, which reduces or eliminates the subsequent expenditure for the graphitization.

The process according to the invention is advantageously performed under protective gas and/or reduced pressure (vacuum). For instance, the process according to the invention is advantageously performed at a pressure of 1 mbar to 1 bar (ambient pressure), especially of 1 to 10 mbar.

Appropriately, the pyrolysis apparatus used is dried before commencement of pyrolysis and purged to virtually free it of oxygen by purging with an inert gas, such as nitrogen or argon or helium. The duration of pyrolysis in the process according to the invention is generally between 1 minute and 48 hours, preferably between ¼ hour and 18 hours, especially between ½ hour and 12 hours at said pyrolysis temperature; the heating time until attainment of the desired pyrolysis temperature may additionally be within the same order of magnitude, especially between ¼ hour and 8 hours. The present process is generally performed batchwise, but it can also be performed continuously.

A C-based pyrolysis product obtained in accordance with the invention comprises charcoal, especially with proportions of graphite and in the specific embodiment also with proportions of silicon oxide. The pyrolysis product optionally comprises proportions of other carbon forms, such as coke, and is particularly low in impurities, for example compounds of B, P, As and Al. The profile of impurities for Al, B, Ca, Fe, Ni, P, Ti and Zn of the pyrolysis product most preferably corresponds to the profile defined above for the graphite mouldings.

The carbohydrate components used in the process according to the invention are preferably monosaccharides, i.e. aldoses or ketoses, such as trioses, tetroses, pentoses, hexoses, heptoses, particularly glucose and fructose, but also corresponding oligo- and polysaccharides based on said monomers, such as lactose, maltose, sucrose, raffinose—to name just a few or derivatives thereof—up to starch, including amylose and amylopectin, the glycogens, the glycosans and fructosans—to name just a few polysaccharides.

If a particularly pure pyrolysis product is required, the process according to the invention is preferably modified by additionally purifying the aforementioned carbohydrates by a treatment using an ion exchanger, in which case the carbohydrate is dissolved in a suitable solvent, advantageously water, more preferably deionized or demineralized water, passing it through a column filled with an ion exchange resin, preferably an anionic or cationic resin, concentrating the resulting solution, for example by removing solvent fractions by heating—especially under reduced pressure—and obtaining the carbohydrate thus purified advantageously in crystalline form, for example by cooling the solution and then removing the crystalline fractions, means of which include filtration or centrifuging. The person skilled in the art is aware of various ion exchangers for removal of different ions. It is possible in principle to connect a sufficient number of ion exchanger steps in series to achieve the desired purity of the sugar solution. Alternatively to purification by means of ion exchangers, however, it is also possible to employ other measures known to those skilled in the art in order to purify the carbohydrate starting materials. Examples here include: addition of complexing agents, electrochemical purification methods, chromatographic methods.

However, it is also possible to use a mixture of at least two of the aforementioned carbohydrates as the carbohydrate or carbohydrate component in the process according to the invention. Particular preference is given in the process according to the invention to a crystalline sugar available in economically viable amounts, as sugar as can be obtained, for example by crystallization of a solution or a juice from sugar cane or beet in a manner known per se, i.e. conventional crystalline sugar, for example refined sugar, preferably a crystalline sugar with the substance-specific melting point/softening range and a mean particle size of 1 μm to 10 cm, more preferably of 10 μm to 1 cm, especially of 100 μm to 0.5 cm: The particle size can be determined, for example—but not exclusively—by means of screen analysis, TEM, SEM or light microscopy. However, it is also possible to use a carbohydrate in dissolved form, for example—but not exclusively—in aqueous solution, in which case the solvent admittedly evaporates more or less rapidly before attainment of the actual pyrolysis temperature. Most preferably, the profile of impurities for Al, B, Ca, Fe, Ni, P; Ti and Zn of the carbohydrate component corresponds to the profile defined above for the graphite mouldings.

Silicon oxide in the context of the present invention is preferably SiOₓ where x=0.5 to 2.5, preferably SiO, SiO₂, silicon oxide (hydrate), aqueous or water-containing SiO₂, in the form of fumed or precipitated silica, moist, dry or calcined, for example Aerosil® or Sipernat®, or a silica sol or gel, porous or dense silica glass, quartz sand, quartz glass fibres, for example light guide fibres, quartz glass beads, or mixtures of at least two of the aforementioned-components. The material is most preferably a silicon dioxide.

In the process according to the invention, preference is given to using silicon dioxides having an internal surface area of 0.1 to 600 m²/g, more preferably of 10 to 500 m²/g, especially of 50 to 400 m²/g. The internal or specific surface area can be determined for example by the BET method (DIN ISO 9277).

Preference is given to using silicon dioxides having a mean particle size of 10 nm to 1 mm, especially of 1 to 500 μm. Here, too, means of determining the particle size include TEM (transelectron microscopy), SEM (scanning electron microscopy) or light microscopy.

The silicon oxide used in the process according to the invention advantageously has a high (99%) to ultra-high (99.9999%) purity, and the total content of impurities, such as compounds of B, P, As and Al, should advantageously be ≦10 ppm by weight, especially ≦1 ppm by weight. Especially preferably, the silicon dioxide used, for Al, B, Ca, Fe, Ni, P, Ti and Zn has a profile of impurities which corresponds to the profile defined above for the graphite mouldings.

In the specific embodiment of the process according to the invention carbohydrate can be used relative to defoamer, i.e. silicon oxide component, calculated as SiO₂, in a weight ratio of 1000:0.1 to 0.1:1000. The weight ratio of carbohydrate component to silicon oxide component can preferably be adjusted to 800:0.4 to 1:1, more preferably to 500:1 to 100:13, most preferably to 250:1 to 100:7.

The carbohydrate component, or the carbohydrate component and the silicon oxide component, can preferably be pyrolysed in powder form or as a mixture. However, it is also possible to subject the carbohydrate or the mixture of carbohydrate and silicon oxide before the pyrolysis to a shaping process. For this purpose, all shaping processes known to those skilled in the art can be employed. Suitable processes, for example bricketting, extrusion, pressing, tableting, pelletization, granulation and further processes known per se are sufficiently well known to those skilled in the art. In order to obtain stable mouldings, it is possible, for example, to add carbohydrate solution or molasses or lignosulphonate or “pentaliquor” (waste liquor from pentaerythritol production) or polymer dispersions for example polyvinyl alcohol, polyethylene oxide, polyacrylate, polyurethane, polyvinyl acetate, styrene-butadiene, styrene-acrylate, natural latex, or mixtures thereof as the binder; preference is given to using high-purity binders.

The apparatus used for the performance of the pyrolysis step of the process according to the invention may, for example, be an induction-heated vacuum reactor, in which case the reactor may be constructed in stainless steel and, with regard to the reaction, is covered or lined with a suitable inert substance, for example high-purity SiC, Si₃N₃, high-purity quartz glass or silica glass, high-purity carbon or graphite, ceramic. However, it is also possible to use other suitable reaction vessels, for example an induction furnace with a vacuum chamber to accommodate a corresponding reaction crucible or trough.

In general, the pyrolysis step of the process according to the invention is performed as follows:

The reaction interior and the reaction vessel are suitably dried and purged with an inert gas which may be heated, for example to a temperature between room temperature and 300° C. Subsequently the carbohydrate or carbohydrate mixture to be pyrolysed, or in the specific embodiment additionally, the silicon oxide as a defoamer component, is introduced as a powder or as a moulding into the reaction chamber or the reaction vessel of the pyrolysis apparatus. The feedstocks can be mixed intimately beforehand, degassed under reduced pressure and transferred into the prepared reactor under protective gas. The reactor may already be preheated slightly. Subsequently, the temperature can be run up continuously or stepwise to the desired pyrolysis temperature and the pressure can be reduced in order to be able to remove the gaseous decomposition products escaping from the reaction mixture as rapidly as possible. Especially as a result of the addition of silicon oxide, it is advantageous to very substantially avoid foam formation in the reaction mixture. After the pyrolysis reaction has ended, the pyrolysis product can be thermally aftertreated for a certain time, advantageously at a temperature in the range from 1000 to 1500° C.

In general, this affords a pyrolysis product or a composition which comprises high-purity carbon.

In addition, the pyrolysis product may have a ratio of carbon to silicon oxide (calculated as silicon dioxide) of 400:0.1 to 0.4:1000, more preferably of 400:0.4 to 4:10; even more preferably of 400:2 to 4:1.3 and especially of 400:4 to 40:7.

According to the graphite content of the pyrolysis product, the pyrolysis product can directly be processed further to mouldings by processes known to those skilled in the art, or is already in the form of mouldings in the case of shaping before the pyrolysis.

However, it may also be necessary to perform a graphitization step. This step can likewise be performed by methods known to those skilled in the art.

Preferably the pyrolysis product, optionally together with a binder and/or further components, is mixed vigorously and homogeneously and subjected to a shaping. It is possible to use all methods specified above for the production of the sugar mouldings. Preference is given to shaping green bodies in extruders or in isostatic presses or in die presses or in extrudate presses. According to the graphite content of the pyrolysis product, there is an optional calcination of the green bodies with exclusion of oxygen at temperatures of 600-1200° C. and/or an optional graphitization in the temperature range of 1800-3000° C.

Suitable binders are preferably those which are cookable at temperatures between 300 and 800° C., for example alginates, cellulose derivatives or other carbohydrates, preferably monosaccharides such as fructose, glucose, galactose and/or mannose and more preferably oligosaccharides such as sucrose, maltose and/or lactose, but also polyvinyl alcohol, polyethylene oxide, polyacrylate, polyurethane, polyvinyl acetate, styrene-butadiene, styrene-acrylate, natural latex, or mixtures thereof or organosilanes. Preference is given to using high-purity binders, i.e. binders which, for Al, B, Ca, Fe, Ni, P, Ti and Zn have a profile of impurities which corresponds to the profile defined above for the graphite mouldings.

The graphite mouldings may consist of graphite to an extent of 30 to 100% by weight, i.e. the pyrolysis product need not be fully graphitized. The graphite mouldings as the carbon source comprise exclusively the fully or partly graphitized pyrolysis product, but it is also possible to add further graphitized or non-graphitized carbon sources via the binder or via the further components. The further components thus preferably comprise at least one carbon source different from the inventive pyrolysis product. This may comprise, for example carbon blacks or activated carbon or coke variants or charcoal variants, or graphites or other carbon compounds which are converted to coke in the course of calcination or in the course of graphitization of the mouldings. More preferably, all constituents of the graphite mouldings, for Al, B, Ca, Fe, Ni, P, Ti and Zn have a profile of impurities which corresponds to the profile defined above for the graphite mouldings.

In the graphitization of SiO₂-containing pyrolysis products, the SiO₂ can react fully or partly with carbon to give SiO or SiC, such that it is possible in this way to obtain products doped with silicon oxides and/or silicon carbides.

The mouldings are preferably electrodes or electrode constituents, or constituents of the furnace, preferably those constituents which come into contact with the melt.

In summary, the process according to the invention for producing solar silicon thus preferably comprises the following step d) and optionally one or more of steps a) to c) and e) to f):
a) purifying at least one carbohydrate solution or a carbohydrate as described above
b) mixing at least one carbohydrate solution with at least one silicon oxide, preferably at least one silicon dioxide
c) producing mouldings from carbohydrate or carbohydrate and silicon oxide as described above
d) pyrolyzing the carbohydrate solution as described above
e) producing mouldings, preferably electrodes, from the pyrolysed carbohydrate
f) graphitizing as described above.

The definitions of metallurgical silicon and solar silicon are common knowledge. For instance, solar silicon has a silicon content of greater than or equal to 99.999% by weight.

The present invention is explained and illustrated in detail by the examples and comparative examples which follow, without restricting the subject matter of the invention.

### EXAMPLES

### Comparative Example 1

Commercial refined sugar was melted in a quartz bottle under protective gas and then heated to about 1600° C. In the course of this, the reaction mixture foamed significantly and some escaped—caramelization was likewise observed, and the pyrolysis product remained stuck to the wall of the reaction vessel.

### Example 1

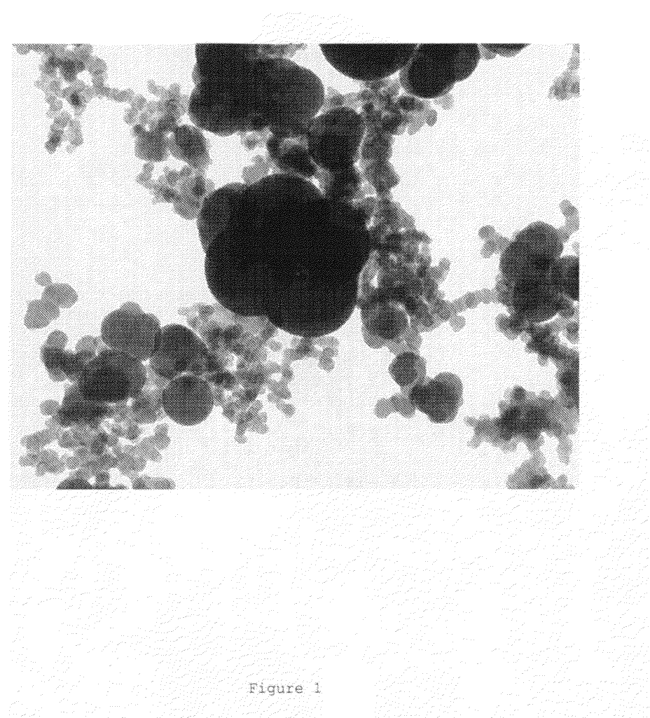

Commercial refined sugar was mixed with SiO₂ (Sipernat® 160) in a weight ratio of 20:1 (sugar:SiO₂), melted and heated to about 800° C. No caramelization was observed, nor did any foam formation occur. What was obtained was a graphite-containing particulate pyrolysis product, which advantageously essentially did not adhere to the wall of the reaction vessel. FIG. 1 shows an electron micrograph of the pyrolysis product from Example 1.

1. A process for producing silicon by reduction of silicon dioxide with carbon, wherein the process is performed in a light arc furnace and in that at least parts of the furnace or of the electrodes are produced from a graphite material which is in turn obtained from a carbon material which is obtained by pyrolysis of at least one carbohydrate.

2. The process according to claim 1, wherein
the pyrolysis of the carbohydrate is performed in the presence of at least one silicon oxide.

3. The process according to claim 1, wherein
the carbohydrate component used is at least one crystalline sugar.

4. The process according to claim 1, wherein
carbohydrate and silicon oxide (each calculated in total) are used in a weight ratio of 1000:0.1 to 0.1:1000.

5. The process according to claim 1, wherein
the pyrolysis is performed in a reactor with exclusion of oxygen.

6. The process according to claim 1, wherein
the pyrolysis is performed at a temperature below 800° C.

7. Process according to claim 1, wherein
the pyrolysis is performed at a pressure between 1 mbar and 1 bar, or in an inert gas atmosphere, or a combination thereof.

8. The process according to claim 1, wherein
the carbohydrate or a carbohydrate mixture or a mixture of a carbohydrate and a silicon oxide is subjected before the pyrolysis to a shaping process, and the resulting moulding is pyrolysed.

9. The process according to claim 1, wherein
the carbohydrate is subjected before pyrolysis to at least one purification step.

10. The process according to claim 1, wherein
the carbohydrate components and/or the silicon oxide component is used in pure or highly pure form, with a content of:
a. aluminium less than or equal to 5 ppm;
b. boron less than 10 ppm to 0.0001 ppt;
c. calcium less than or equal to 2 ppm;
d. iron less than or equal to 20 ppm;
e. nickel less than or equal to 10 ppm;
f. phosphorus less than 10 ppm to 0.0001 ppt;
g. titanium less than or equal to 2 ppm;
h. zinc less than or equal to 3 ppm and with a sum of the abovementioned impurities of less than 10 ppm.

11. Graphite mouldings, comprising graphite mouldings doped with silicon oxides, silicon carbide, or a combination thereof.

12. The graphite mouldings according to claim 11, comprising the following profile of impurities:
a. aluminium less than or equal to 5 ppm;
b. boron less than 10 ppm to 0.0001 ppt;
c. calcium less than or equal to 2 ppm;
d. iron less than or equal to 20 ppm;
e. nickel less than or equal to 10 ppm;
f. phosphorus less than 10 ppm to 0.0001 ppt;
g. titanium less than or equal to 2 ppm;
h. zinc less than or equal to 3 ppm.

13. The graphite mouldings according to claim 11, comprising a ratio of carbon to silicon (calculated as silicon dioxide) of 400:0.1 to 0.4:1000.

14. The process according to claim 1, wherein the process is for producing solar silicon.

15. The process according to claim 1, wherein the carbon material is obtained by pyrolysis of at least one sugar.

16. The process according to claim 1, wherein
the pyrolysis of the carbohydrate is performed in the presence of a form of silicon dioxide selected from a fumed or precipitated silica or of a silica gel.

17. The process according to claim 1, wherein
the pyrolysis is performed at a temperature between 800 and 1700° C.

18. The process according to claim 8, wherein
the shaping process is selected from bricketting, extrusion, compression, tableting, pelletization and granulation.

19. The process according to claim 9, wherein
the carbohydrate is subjected before pyrolysis to at least one ion exchanger.

20. The graphite mouldings according to claim 11, wherein the mouldings are graphite electrodes.
